(19) United States
(12) Patent Application Publication
(10) Pub. No.: US 2025/0132635 A1
(43) Pub. Date: Apr. 24, 2025

(54) ELECTRIC MACHINE HAVING A CORRUGATED COUPLING ELEMENT

(71) Applicant: Rolls-Royce Deutschland Ltd & Co KG, Blankenfelde-Mahlow (DE)

(72) Inventors: Behnam HOUSHMAND, München (DE); Adrian LEVU, München (DE); Gunar REINICKE, Gauting (DE); Uwe Peter ZEECK, Berlin (DE); Gideon Daniel VENTER, Berlin (DE); Björn PETERSEN, Berlin (DE)

(21) Appl. No.: 18/721,860

(22) PCT Filed: Dec. 13, 2022
(86) PCT No.: PCT/EP2022/085623

§ 371 Date: Jun. 19, 2024

(30) Foreign Application Priority Data
Dec. 20, 2021 (DE) 10 2021 214 730.5

(51) Int. Cl. H02K 7/00; B64D 27/30; F16D 3/76

(52) U.S. Cl. CPC H02K 7/003; B64D 27/30; F16D 3/76

(57) ABSTRACT

The invention relates to an electric machine (1; 1′), comprising: a stator (10); a rotor (11) that can be rotated relative to the stator (10); a shaft (12) that can be rotated relative to the stator (10); and a flexible coupling element (13; 13′; 13″) having a first connecting section (130; 130′) fixed to the rotor (11) and a second connecting section (131; 131′; 131″) fixed to the shaft (12). which connecting sections have different diameters (D1, D2) and are connected to one another via an alternately curved connecting surface (132; 132′).

This application is the National Stage of International Application No. PCT/EP2022/085623, filed Dec. 13, 2022, which claims the benefit of German Patent Application No. DE 10 2021 214 730.5, filed Dec. 20, 2021. The entire contents of these documents are hereby incorporated herein by reference.

### BACKGROUND

The present disclosure relates, for example, to an electric machine, a vehicle including such an electric machine, and a method for producing an electric machine.

In the case of electric motors and other electric machines, the aim is to continuously improve the target variables of energy efficiency, power-to-weight ratio, reliability, and service life. For low energy consumption in mobile applications (e.g., in vehicle construction), a low weight of the drives is also important. The requirements described apply especially to use in aircraft. Further, there may be external forces acting. In the case of an aircraft, side winds or the like acting on a propeller driven by an electric motor may lead to axial and radial forces being exerted on a shaft connecting the electric motor to the propeller, for example. As a rule, therefore, a correspondingly stiff mounting is provided for the shaft in order to absorb these forces. However, such mountings often have a relatively high weight. In addition, the forces mentioned may lead to wear on the corresponding components.

### SUMMARY AND DESCRIPTION

The scope of the present disclosure is defined solely by the appended claims and is not affected to any degree by the statements within this description.

The present embodiments may obviate one or more of the drawbacks or limitations in the related art. For example, an improved electric machine is provided.

According to one aspect, an electric machine is provided, for example for a vehicle (e.g., for an aircraft). The electric machine includes a stator, a rotor that is rotatable relative to the stator, a shaft that is rotatable relative to the stator. and a flexible coupling element. The coupling element has a first connecting section fixed to the rotor and a second connecting section fixed to the shaft. The two connecting sections have different diameters and are connected to one another via an alternately curved connecting surface.

This configuration of the coupling element allows axial and radial translation as well as a tilting movement of the shaft relative to the stator. At the same time, a torque may be transmitted between the rotor and the shaft by the coupling element. The connecting surface of the coupling element forms a flexible bellows. The coupling element decouples the rotor from the shaft elastically in the axial and radial directions. There is no need for any lubricant to achieve this, and therefore, the electric machine is particularly suitable for use as a direct drive unit without the need for a lubricating system. The connecting surface is alternately curved. In other words, the connecting surface has at least one curve (e.g. two, three, four, five, six, seven, or more curves) in one direction and at least one curve (e.g., two, three, four, five, six, seven, or more curves) in an opposite direction thereto. The connecting surface may include a plurality of separate sections. The first connecting section and/or the second connecting section may be formed by a plurality of subsections (e.g., mutually spaced subsections). Further, the first connecting section and/or the second connecting section may be formed by a single, uninterrupted section.

The shaft may be arranged and aligned concentrically with the rotor. The shaft and the rotor may overlap when viewed in the axial direction. This allows a compact construction.

The stator may be arranged, such that the stator surrounds the shaft on the outside. The shaft may thus extend into the stator. This too allows a compact construction.

Provision may be made for the rotor to surround the stator on the outside. The electric machine may thus be configured as an external rotor machine. The coupling element enables efficient and robust coupling of the external rotor machine to the shaft.

The connecting surface of the coupling element may have annular (e.g., mutually coaxial) curved sections (e.g., in the form of annular corrugations). Provision may be made for the coupling element to be of concentrically corrugated design. This allows particularly high flexibility in the axial and radial directions and, at the same time, transmission of high torques.

In one embodiment, the curved sections have successively (e.g., continuously) smaller diameters, starting from the first connecting section.

The first connecting section and/or the second connecting section may each have a flange. This allows secure fastening.

Alternatively or in addition, the second connecting section has, for example, a polygonal connecting section (e.g., a cuboidal pin). This allows positive connection and reliable torque transmission.

The coupling element may be of funnel-shaped design. The connecting sections are arranged axially offset from one another, for example. This simultaneously allows the bridging of a radial spacing and of an axial spacing between the two connecting sections.

The coupling element includes, for example, a flat material (e.g., a steel sheet). The coupling element has, for example, a material thickness in the millimeter range (e.g., less than 2 mm or about 1 mm or less). This allows transmission of high torques and, at the same time, a low weight. Optionally, various regions of the coupling elements have different (e.g., significantly different) material thicknesses.

The coupling element may be of integral design. This allows simple production and particularly low wear.

Optionally, at least one opening is formed in the connecting surface. This allows ventilation and, in addition, a reduction in weight.

In this case, provision may be made for a rim of the opening (e.g., or in each case of the plurality of openings) to have a greater material thickness than adjacent regions of the connecting surface. In this way, cracking of the rim may be prevented.

Optionally, a plurality of openings is formed in the connecting surface. This allows an effective reduction in weight.

The openings in the connecting surface may be configured such that the openings cover a larger area than the sections of the connecting surface that lie in between the openings. A particularly effective reduction in weight is possible in this way.

The connecting surface may be formed by a plurality of arms. This allows reliable connection and, once again, a particularly low weight.

The first connecting section may further be formed by a plurality of mutually spaced sections. An even greater reduction in weight is possible in this way.

The rotor drives a propeller, for example. This enables thrust to be generated, for example.

According to one aspect, a vehicle (e.g., an aircraft) is specified. The vehicle (e.g., aircraft) includes the electric machine according to any embodiment described herein. In the case of a vehicle (e.g., an aircraft), the advantages described above are especially marked.

According to one aspect, a method for producing an electric machine is specified (e.g., the electric machine according to any embodiment described herein). The method includes supplying a stator, a rotor that is rotatably mounted relative to the stator, a shaft that is rotatably mounted relative to the stator, and a flexible coupling element having a first connecting section and a second connecting section. The first connecting section and the second connecting section have different diameters and are connected to one another via an alternately curved connecting surface. The method further includes mounting the coupling element on the rotor by the first connecting section and on the shaft by the second connecting section.

Optionally, the method includes the preceding step of producing the coupling element by deep drawing. This allows particularly quick and low-cost production.

Alternatively or in addition, the method also includes the preceding step of producing the coupling element by additive manufacture. This allows a specifically optimized geometry and variable material thicknesses.

### BRIEF DESCRIPTION OF THE DRAWINGS

FIG. 1 shows an aircraft with a number of electric machines for driving a number of propellers;

FIG. 2 shows a schematic diagram of an electric machine for an aircraft according to FIG. 1, having a stator, a rotor, and a coupling element;

FIG. 3 shows an electric machine of the aircraft according to FIG. 1 in a perspective view in the direction of the coupling element;

FIG. 4 shows the coupling element of the electric machine according to FIG. 3;

FIG. 5 shows a cutaway view of the coupling element according to FIG. 4;

FIGS. 6A and 6B show various acts in the production of the electric machine according to FIG. 3;

FIG. 7 shows an electric machine for the aircraft according to FIG. 1 in a perspective view in the direction of the coupling element;

FIG. 8 shows the coupling element of the electric machine according to FIG. 7;

FIGS. 9A-9C show various acts in the production of the electric machine according to FIG. 7;

FIG. 10 shows a deep drawing tool for producing the coupling element according to FIG. 4;

FIG. 11 shows a laser deposition welding device for producing the coupling element according to FIG. 7;

FIG. 12 shows a coupling element for the electric machine according to FIG. 3, and for the electric machine according to FIG. 7;

FIG. 13 shows part of a connecting section of the coupling element according to

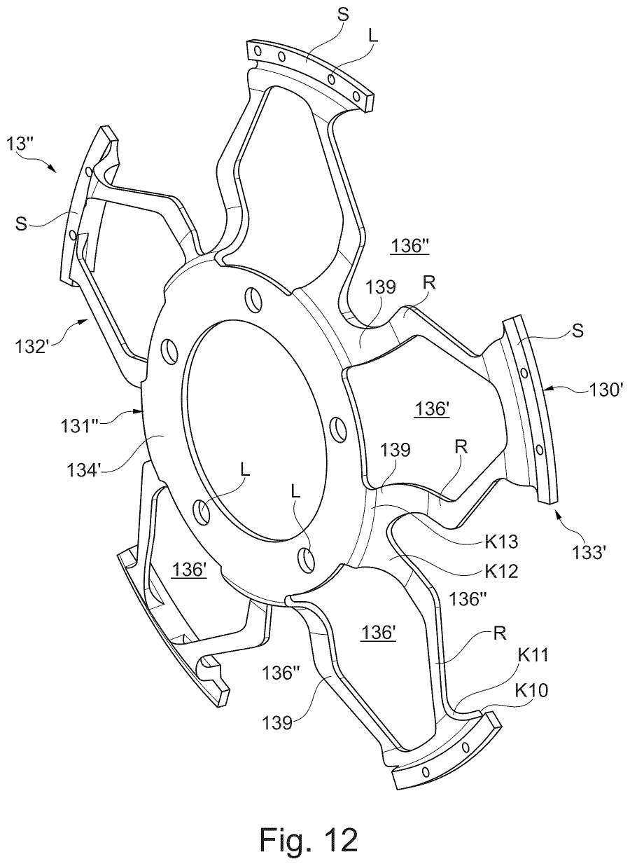

FIG. 12 in a plan view; and

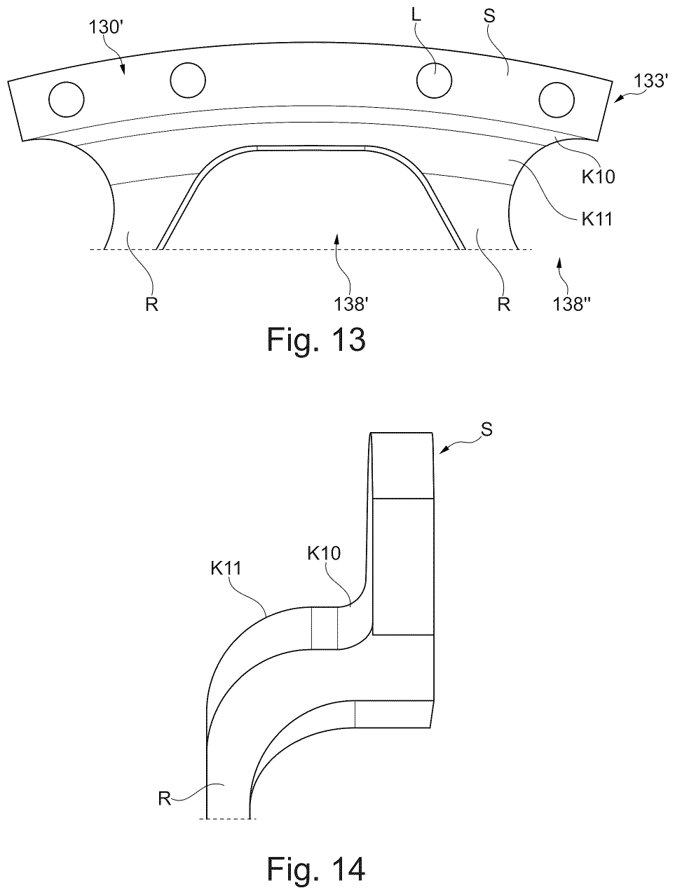

FIG. 14 shows the part of the connecting section of the coupling element according to FIG. 13 in a side view.

### DETAILED DESCRIPTION

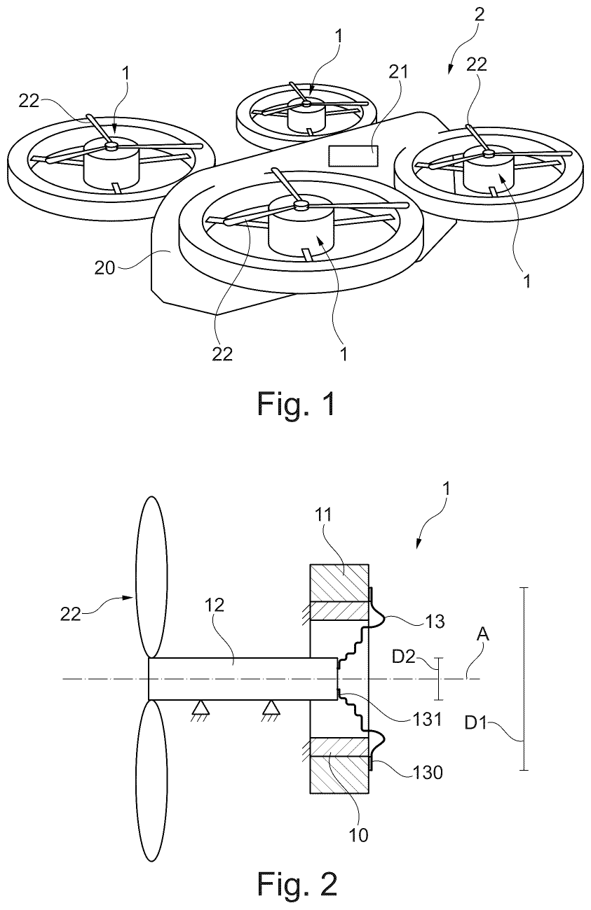

FIG. 1 shows an aircraft 2 in the form of an air taxi. The aircraft 2 includes a cabin 20 and a plurality of (e.g., four) electric machines 1, each in the form of an electric motor. Each of the electric machines 1 drives one propeller 22. For this purpose, each of the propellers 22 is operatively connected to a rotor of the respective electric machine 1 (e.g., secured thereon). A battery 21 supplies electric current for operation of the electric machines 1. In the present case, the electric machines 1 involve direct drives.

FIG. 2 illustrates the fundamental construction of the electric machines 1, which are of a same construction in the example according to FIG. 1.

In the embodiment of FIG. 2, the electric machine 1 includes a stator 10, a rotor 11 that is rotatable relative to the stator 10 about an axis of rotation A, a shaft 12 that is rotatable relative to the stator 10 about the axis of rotation A, and a coupling element 13 having a first connecting section 130 that is, for example, annular and fixed to the rotor 11, and a second connecting section 131 that is, for example, likewise annular and fixed to the shaft 12. In comparison with one another, the connecting sections 130, 131 have different diameters D1, D2. Further, the connecting sections 130, 131 are connected to one another via an alternately curved connecting surface 132.

This allows transmission of relatively high torques with a relatively low weight. Torques may be transmitted in both directions. The lateral and axial stiffness and bending stiffness may be kept low. At the same time, the coupling element 13 allows a particularly simple construction of the electric machine 1. Further, the coupling element 13 is substantially wear-free and may be adapted to different motor designs.

The electric machine 1 is configured as an external rotor machine. The rotor 11 surrounds the stator 10. The stator 10 is arranged within the rotor 11. The stator 10 is secured on a loadbearing structure. The loadbearing structure is secured on the aircraft 2. The shaft 12 is mounted rotatably on the loadbearing structure (and/or on the stator 10). The shaft 12 is arranged coaxially and concentrically with the rotor 11 and the stator 10.

Thus, the stator 10 is arranged between the rotor 11 and the shaft 12. There is a spacing between the rotor 11 and the shaft 12. The coupling element 13 bridges this spacing.

The coupling element 13 is of corrugated design. The coupling element 13 is flexible and allows an axial movement (e.g., along the axis of rotation A) and a radial movement (e.g., perpendicularly to the axis of rotation A) of the shaft 12 relative to the rotor 11. Further, tilting movements of the shaft 12 relative to the rotor 11 are made possible. At the same time, the geometry of the coupling element, which is explained in detail below, provides transmission of torques between the rotor 11 and the shaft 12 around the axis of rotation A.

The propeller 22 is operatively connected to the shaft 12 (e.g., being secured on the shaft 12 in the present case). Via the shaft 12, the propeller 22 may be rotated by rotating the rotor 11 relative to the stator 10.

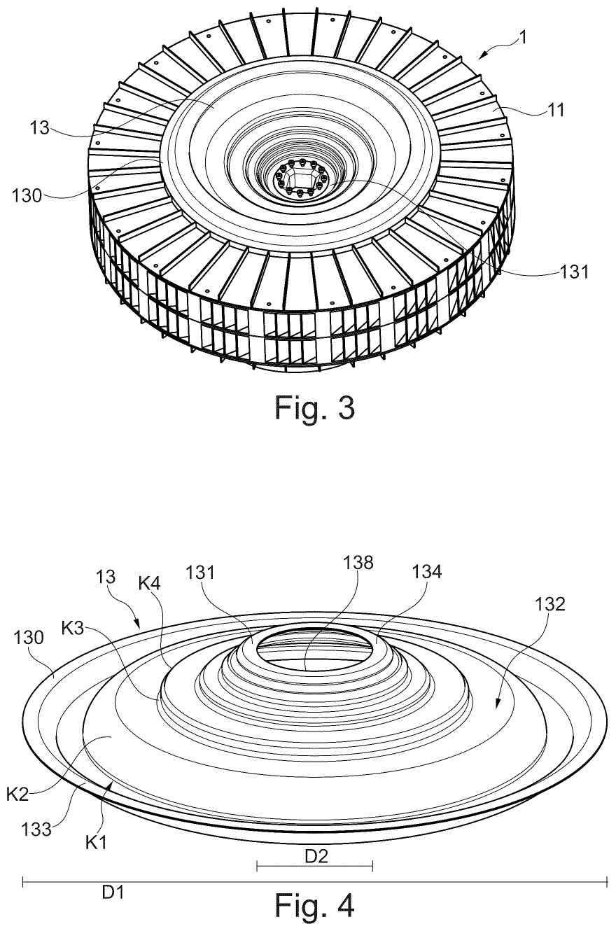

FIG. 3 shows the electric machine 1. As is apparent, the coupling element 13 is attached to the external rotor 11. The first connecting section 130 is annular. In the present case, the second connecting section 131 is also annular. The coupling element 13 is of funnel-shaped design. The coupling element 13 thus forms a depression that may be described as trough-shaped. The connecting sections 130, 131 are arranged offset from one another in the axial direction.

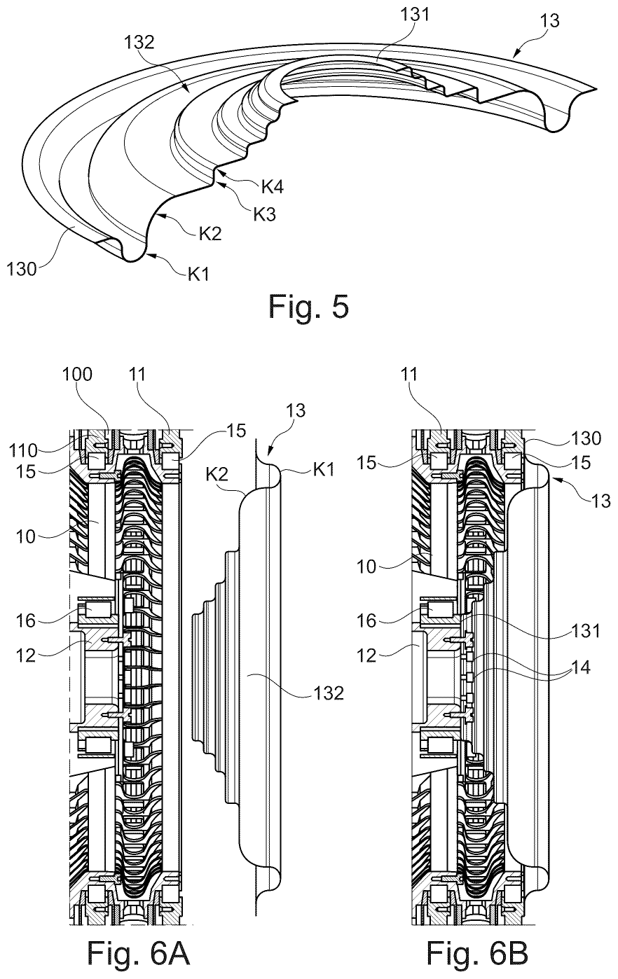

Further details of the geometry of the coupling element 13 are apparent especially from FIGS. 4 and 5.

Thus, the first connecting section 130 has a flange 133, and the second connecting section 131 has a flange 134. The flange 133 of the first connecting section 130 is annular, and has a larger diameter D1 than the flange 134 of the second connecting section 131 (e.g., diameter D2). The first connecting section 130 forms a circular outer rim of the coupling element 13. The second connecting section 131 forms a circular opening 138. In the example shown, the flange 133 of the first connecting section 130 and the flange 134 of the second connecting section 131 extend in mutually parallel planes.

The alternately curved connecting surface 132 extends between the first connecting section 130 and the second connecting section 131.

The connecting surface 132 has a plurality of (e.g., 11; two or more; more than 3,more than 4, more than 5, or more than 10) annular curved sections, of which some are denoted by K1-K4. The curved sections K1-K4 are oriented so as to be coaxial with one another. The curved sections K1-K4 form circular steps. The connecting surface 132 is corrugated. In the cross section shown in FIG. 5, the coupling element 13 has regions that are curved alternately to the left and to the right. The coupling element 13 has concave regions and convex regions in alternation.

In the example shown, the outer curved sections have a greater width in a direction perpendicular to the axis of rotation A than the inner curved sections. In the present case, the annular curved sections have a width that, when viewed from the outside inward, becomes successively and continuously smaller (e.g., in a direction perpendicular to the axis of rotation A). The outermost curved sections K1, K2 also have larger radii of curvature than the inner curved sections in a plane extending perpendicularly through the axis of rotation A (e.g., in the section according to FIG. 5).

Flat sections (e.g., with surfaces parallel to the axis of rotation A) and cylindrical sections are provided in alternation between a plurality of the annular curved sections.

The coupling element 13 forms a bellows. The coupling element 13 may also be referred to as a coupling bellows.

FIG. 6A illustrates the alignment of the coupling element 13 with respect to the unit consisting of the rotor 11 and the stator 10 before assembly. The stator 10 has fins for cooling the coils. The rotor 10 is mounted rotatably on the stator 10 using at least one (e.g., a plurality of; two) bearings 15. Also shown is one end of the shaft 12, at which the shaft 12 is mounted by a bearing 16 (e.g., in the present case, on a section of the loadbearing structure on which the stator 10 is also mounted).

In the example shown, the electric machine 1 is in the form of a transverse flux motor. The rotor 11 has a magnet holder 110, to which a plurality of magnets 11 is fixed (e.g., in the form of permanent magnets). The stator 10 has a coil holder 100, to which electric coils are fixed. The coils may be supplied with electric current (e.g., an alternating current, such as a three-phase alternating current). As a result of this, a magnetic rotating field is generated, by which a force is exerted on the magnets 11, which then brings about a rotation of the rotor 11 relative to the stator 10 around the axis of rotation A. The magnetic fields act in the axial direction in this case.

For assembly, the coupling element 13 is inserted into the stator 10 and secured.

FIG. 6B shows the assembled state, where the second connecting section 131 is secured on the shaft 12 by screws 14. The first connecting section 130 may be welded to the rotor 11, secured non-positively thereon, or likewise secured by screws or the like.

In the assembled state, the first connecting section 130 rests against the rotor 11, against an end face of the rotor 11. Starting from there, the connecting surface 132 initially forms an annular bead directed away from the shaft 12 in an axial direction, and then extends in a corrugated funnel shape toward the shaft 12.

The coupling element 13 is a deep drawn part. The coupling element is produced from a flat material (e.g., in the present case, from a steel sheet). For example, it would also be possible to produce the coupling element from titanium. For example, it is possible to use materials of this kind that are already approved for aeronautical use. Alternatively, the coupling element may be produced from plastic. The coupling element 13 has a material thickness in the millimeter range. The material thickness is of the same order of magnitude in all regions of the coupling element 13. For example, the material thickness at all points is in the range of +/−50% around a value (e.g., in the range of +/−10% around a value). In the present case, the value of the material thickness is 1 mm. The coupling element 13 is of integral design. Further, the coupling element 13 is constructed from a single material.

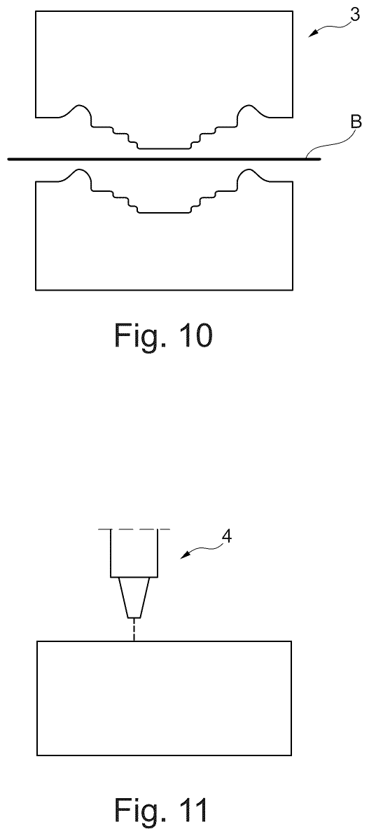

For production, a deep drawing tool 3 is used, as shown in FIG. 10. This has an upper tool half and a lower tool half. A sheet B is inserted between the upper tool half and the lower tool half. The tool halves are then pressed against one another, with the result that the sheet is deformed between the tool halves, and the coupling element 13 is formed.

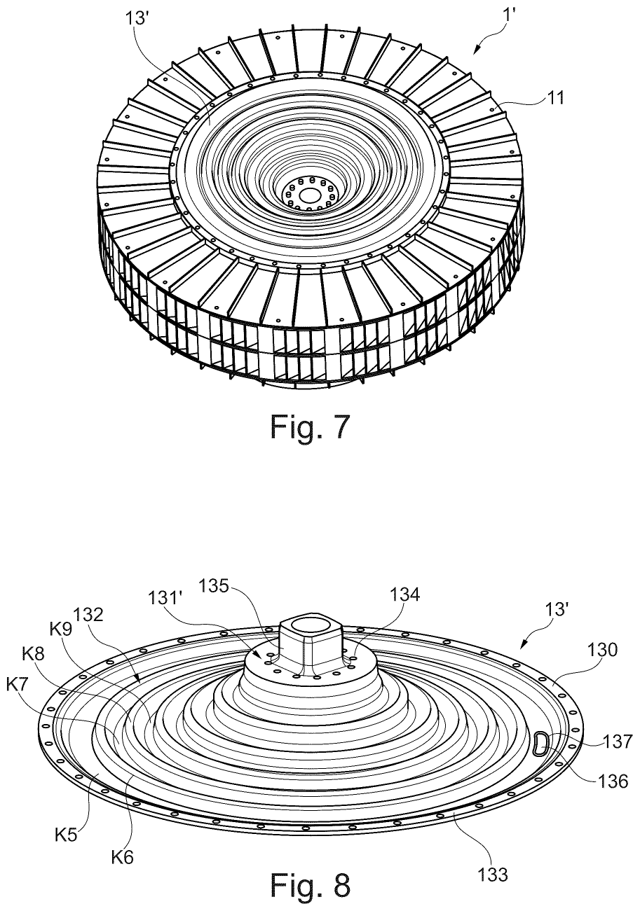

FIG. 7 shows an electric machine 1′ that is constructed in the same way as the electric machine 1 described above, with the sole difference that, in the case of the electric machine 1′ according to FIG. 7, a coupling element 13′ produced in a different way and with a slightly different shape is installed.

As shown in FIG. 8, the second connecting section 131′ of the coupling element 13′ has, in addition to the flange 134, a positive engagement element (e.g., in this case, in the form of a polygonal connecting section 135). The polygonal connecting section 135 has a polygonal (e.g., in this case, square) outer periphery.

Further, the curved sections, of which a number are denoted by K5-K9, are of uniformly corrugated design. Apart from the different diameter, the curved sections are of the same width and height (e.g., approximately or generally the same width and/or height) as one another. Alternatively, some or all of the curved sections are of different width and/or height from one another.

The material thickness differs greatly in different regions of the coupling element 13′ (e.g., by more than a factor of 2, more than a factor of 5, or even more than a factor of 10). Thus, for example, the flange 134 is significantly thicker than the connecting surface 132.

Optionally, one or more openings 136 are formed in the coupling element 13′ (e.g., in the connecting surface 132), as illustrated in FIG. 8. The opening 136 serves for ventilation. A rim 137 of the opening 136 is configured to be thicker than surrounding regions of the connecting surface (e.g., to have a greater material thickness). It is thereby possible to keep stresses in the rim region.

The coupling element 13′ is produced by additive manufacture (e.g., by a 3D printer). In the present case, the coupling element 13′ is produced by laser deposition welding. During this process, the coupling element is produced additively by a laser deposition welding device 4 illustrated in FIG. 11. During this process, material is deposited in a number of layers and melted by a laser. This manufacturing method allows a particularly large amount of freedom in the geometry of the coupling element 13′.

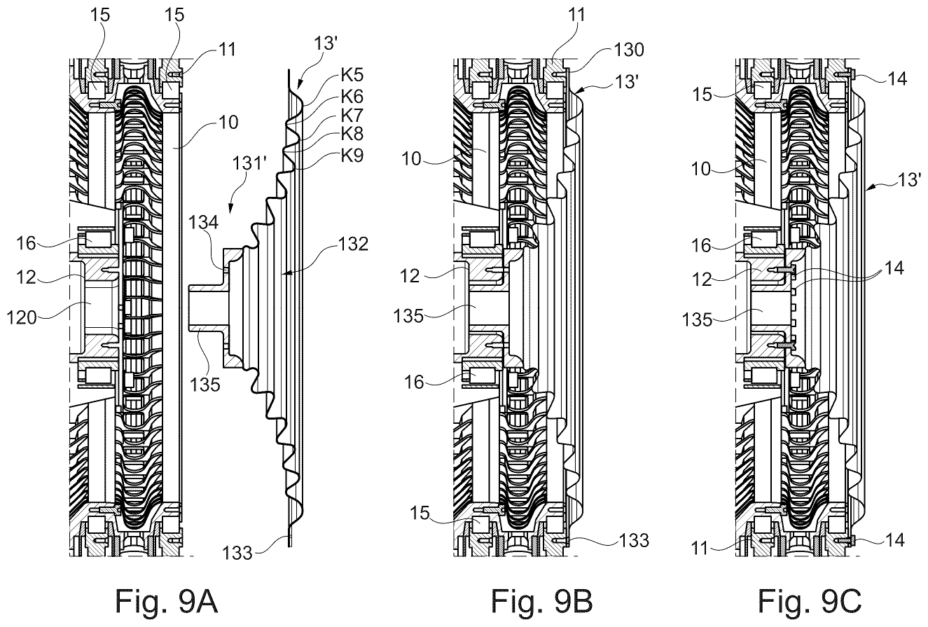

FIGS. 9A to 9C show various stages in the production of the electric machine 1′. As explained above in connection with FIGS. 6A and 6B, the coupling element 13′ is inserted and secured. During this process, the polygonal connecting section 135 engages in a matching socket 120 in an axial end of the shaft 12 to form a positive connection.

FIGS. 12 to 14 show another coupling element 13″ that may optionally include the electric machine 1 according to FIG. 3 and the electric machine 1′ according to FIG. 7 instead of the coupling element 13; 13′ illustrated in each of these figures.

The coupling element 13″ in FIGS. 12 to 14 has a first connecting section 130′ that may be fixed (e.g., and, in the assembled state, is fixed) on the rotor 11, and a second connecting section 131″ that may be fixed (e.g., and, in the assembled state, is fixed) on the shaft 12. The first connecting section 130′ and the second connecting section 131′ have different diameters and are connected to one another by an alternately curved connecting surface 132′.

The connecting surface 132′ has a plurality of sections that are each formed by an arm R. An opening 136′, 136″ is in each case formed between two adjacent arms R. The openings 136′, 136″ cover a larger area than the arms R. Some (e.g., five) of the openings 136′ have a continuous rim. Other (e.g., five) openings 136″ have an open rim. In the example under consideration, the coupling element 13″ is of star-shaped design.

The first connecting section 130′ is formed by a plurality of (e.g., five) subsections S spaced apart from one another in the circumferential direction. Each of the subsections S is in the form of a circular arc. The subsections S are arranged along a common circle. The second connecting section 131″ is of circular design.

Each of the arms R extends from an extension 139 on the second connecting section 131″ to a subsection S of the first connecting section 130′. Two arms R in each case start from a common extension 139 on the second connecting section 131″. Two arms R in each case extend to a common subsection S of the first connecting section 130′. Each arm R is brought together with two different arms on the first connecting section 130′ and on the second connecting section 131″. One arm R (e.g., each arm R) starts from an extension 139 together with a first, different arm R, and merges into a subsection S together with a second, different arm R. The first, different arm R and the second, different arm R are spaced apart from one another. The respective arm R is arranged between the first and second, different arms R.

The arms R each have a bend (e.g., in the circumferential direction). In this case, the bend in adjacent arms R is oriented alternately in the opposite direction. As viewed from the extension 139, the two arms R starting therefrom bend away from one another at the respective bend. The two respective arms R merging into a subsection S of the first connecting sections 130′ are inclined relative to one another (e.g., in a V shape).

A plurality of holes L in the connecting sections 130′, 131″ enable screw fastening to the rotor 11 and to the shaft 12. In the present case, the coupling element 13″ is of integral design. The coupling element 13″ may be produced as a stamped and bent part or by additive manufacture, for example.

The invention is not limited to the above-described embodiments, and different modifications and improvements may be carried out without deviating from the concepts described here. Any of the features may be used separately or in combination with any other features, unless they are mutually exclusive, and the disclosure extends to and includes all combinations and subcombinations of one or more features that are described herein.

While the present disclosure has been described in detail with reference to certain embodiments, the present disclosure is not limited to those embodiments. In view of the present disclosure, many modifications and variations would present themselves, to those skilled in the art without departing from the scope of the various embodiments of the present disclosure, as described herein. The scope of the present disclosure is, therefore, indicated by the following claims rather than by the foregoing description. All changes, modifications, and variations coming within the meaning and range of equivalency of the claims are to be considered within the scope.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

1. An electric machine comprising:
a stator;
a rotor that is rotatable relative to the stator;
a shaft that is rotatable relative to the stator; and
a flexible coupling element having a first connecting section fixed to the rotor and a second connecting section fixed to the shaft, the first connection section and the second connecting section having different diameters and being connected to one another via an alternately curved connecting surface.

2. The electric machine of claim 1, wherein the shaft is arranged concentrically with the rotor.

3. The electric machine of claim 1, wherein the stator surrounds the shaft on an outside.

4. The electric machine of claim 1, wherein the rotor surrounds the stator on an outside.

5. The electric machine of claim 1, wherein the alternately curved connecting surface has annular curved sections.

6. The electric machine of claim 5, wherein the annular curved sections have successively smaller diameters, starting from the first connecting section.

7. The electric machine of claim 1, wherein the first connecting section and the second connecting section each have a flange.

8. The electric machine of claim 1, wherein the second connecting section has a polygonal connecting section.

9. The electric machine of claim 1, wherein the flexible coupling element is of funnel-shaped design.

10. The electric machine of claim 1, wherein the coupling element comprises a flat material.

11. The electric machine of claim 1, wherein the flexible coupling element is of integral design.

12. The electric machine of claim 1, wherein an opening is formed in the alternately curved connecting surface.

13. The electric machine of claim 12, wherein a rim of the opening has a greater material thickness than adjacent regions of the alternately curved connecting surface.

14. The electric machine of claim 12, wherein a plurality of openings are formed in the alternately curved connecting surface.

15. The electric machine of claim 14, wherein the openings in the alternately curved connecting surface cover a larger area than sections of the alternately curved connecting surface that lie in between the openings.

16. The electric machine of claim 1, wherein the alternately curved connecting surface is formed by a plurality of arms.

17. The electric machine of claim 1, wherein the first connecting section is formed by a plurality of mutually spaced sections.

18. The electric machine of claim 1, wherein the rotor is configured to drive a propeller.

19. A vehicle comprising: an electric machine comprising:
a stator;
a rotor that is rotatable relative to the stator;
a shaft that is rotatable relative to the stator; and
a flexible coupling element having a first connecting section fixed to the rotor and a second connecting section fixed to the shaft, the first connection section and the second connecting section having different diameters and being connected to one another via an alternately curved connecting surface.

20. A method for producing an electric machine the method comprising:
supplying a stator, a rotor that is rotatably mounted relative to the stator, a shaft that is rotatably mounted relative to the stator, and a flexible coupling element having a first connecting section and a second connecting section the first connecting section and the second connecting section having different diameters and being connected to one another via an alternately curved connecting surface; and
mounting the flexible coupling element on the rotor by the first connecting section and on the shaft by the second connecting section.

21. The method of claim 20, further comprising producing the flexible coupling element by deep drawing prior to the supplying and the mounting.

22. The method of claim 20, further comprising producing the flexible coupling element by additive manufacture.
